(19) United States
(12) Patent Application Publication
(10) Pub. No.: US 2017/0241077 A1
(43) Pub. Date: Aug. 24, 2017

(54) A SCREEN CYLINDER

(71) Applicant: AIKAWA FIBER TECHNOLOGIES TRUST, Sherbrooke (CA)

(72) Inventor: Robert Gooding, Montreal (CA)

(73) Assignee: AIKAWA FIBER TECHNOLOGIES TRUST, Sherbrooke, QC (CA)

(21) Appl. No.: 15/518,846

(22) PCT Filed: Oct. 12, 2015
(86) PCT No.: PCT/FI2015/050683

§ 371 Date: Apr. 13, 2017

(30) Foreign Application Priority Data
Oct. 14, 2014 (FI) 20145903

(51) Int. Cl. D21D 5/16; B01D 35/00; B01D 29/13

(52) U.S. Cl. CPC D21D 5/16; B01D 29/13; B01D 35/00

(57) ABSTRACT

The present invention relates to a screen cylinder that is particularly suitable for screening, filtering, fractionating, or sorting cellulose pulp or fiber suspensions of the pulp and paper industry or other similar suspensions. The present invention relates more particularly to screening devices of the type comprising a plurality of screen wires positioned axially and at a small spacing parallel to each other, and a plurality of bar-wires arranged in a reverse orientation to the screen wires.

### CROSS-REFERENCE TO RELATED APPLICATIONS

This application is a §371 filing of PCT application PCT/FI2015/050683 filed on Oct. 12, 2015, which claims priority from Finnish application FI 20145903 filed on Oct. 14, 2014. The disclosures of these applications are included by reference herein in their entirety.

### FIELD OF THE INVENTION

The present invention relates to a screen cylinder that is particularly suitable for screening, filtering, fractionating, or sorting cellulose pulp or fibre suspensions of the pulp and paper industry or other similar suspensions. The present invention relates more particularly to screening devices of the type comprising a plurality of screen wires positioned axially and at a small spacing parallel to each other. The plurality of screen wires forms a screening surface facing the pulp or fibre suspension to be screened and adjacent wires form screening openings therebetween allowing an accept portion of the pulp or fibre suspension to flow therethrough.

### BACKGROUND OF THE INVENTION

Some of the first wire screens that appeared on the market had a smooth surface, which had been adapted from screens used for filtration. The constituent wires had a generally triangular shape, with one side of the generally triangular wire forming the surface facing the pulp suspension to be screened. One very significant problem resulting from the use of smooth cylinders was that screen capacity was very low, with the screen exhibiting a very high hydraulic resistance and the screen openings quickly filling with pulp fibres. This problem was solved by the development of contoured screen surfaces. The contours are present circumferentially, and can be created by tilting the screen wires. Alternatively, the side of the generally-triangular wire facing the pulp suspension to be screened can have a more complex, non-planar, shape to generate the contour, as is described in U.S. Pat. No. 5,255,790. In other alternative screen configurations, both a more complex wire shape and tilting have both been used.

Contours may be circumferentially symmetric relative to the screening openings defined between adjacent wires. The problem with symmetric contours is that the flow of the pulp suspension being presented to the contour is highly dissymmetric. There is typically a rotor on the side of the cylinder facing the pulp suspension to be screened, although in some cases the cylinder is rotated relative to some stationary structures to create a similar effect as the moving rotor adjacent a stationary cylinder. In the most typical case of the moving rotor and stationary cylinder, the rotor induces a circumferential motion in the pulp suspension and this flow is more or less parallel to the surface of the cylinder. A small part of this generally circumferential flow turns and passes more or less radially through each of the openings in the screen cylinder. A dissymmetric contour shape solves the problem of a dissymmetric flow and in particular, a flow that has very different flow patterns on the upstream and downstream sides of the opening since the character and design objectives for the impinging flow is somewhat different than the downstream flow.

The contour formed at the entry to each of the screen openings serves one or more of the following functions: First, the contour may streamline the flow that turns from the generally circumferential flow and passes radially through the opening, and thus acts to avoid the creation of vortices within the opening that might otherwise increase hydraulic resistance and limit capacity. Second, the contour may induce turbulence at the surface of the screen cylinder to break up any weakly-bound flocs of fibres approaching the opening or any loose accumulations of fibres within the opening. Finally, the contour may avoid the creation of a localized flow bifurcation at the entry to the opening, which can cause fibres to become immobilized and accumulate.

Various wire and contour shapes have been proposed with the goal of creating an optimal design. A typical contour is dissymmetric with a gradual slope adjacent the downstream side of the opening and an abrupt step on the upstream side of the opening. The particular features on the upstream and downstream sides of the opening are developed in consideration of the strong circumferential flow induced by the rotor.

DE-U1-9108129.7 discusses, as an example of a document disclosing a number of different cross sections for the screening bars or wires, a wedge wire screen cylinder for sorting fiber suspensions. The basic approach is that the screen cylinder is formed of identical wires having a shaped end extending to a constant radius from the cylinder axis. The document teaches several options for the end shapes for the wires including a slanted surface facing the fiber suspension to be screened, i.e. away from the support rings combining the identical wires to a screen cylinder. In accordance with the German document it is known that irregular end surface of the wires at their shaped ends, i.e. surfaces not parallel with the circumference of the screen cylinder improves the screening capacity and quality by creating micro turbulence on the screening surface. It has, for instance, been taught in the document that wires having a slanted shaped end surface may be arranged side by side either such that each wire has its shaped end surface slanting in the same direction or such that at one point of the circumference of the screen cylinder a set of wires have been turned to have their shaped end surfaces slanting in an opposite direction compared to a set of earlier wires or such that adjacent wires have their shaped end surfaces slanting in opposite directions. In fact, the turning of every second wire in a screen cylinder such that their shaped end surfaces are slanting in opposite direction compared to the shaped end surfaces of the rest of the wires results in a milder or weaker turbulence than if all the shaped end surfaces were slanting in the same direction. In any case, as the radius of the shaped end surfaces of all wires of the screen cylinder is constant, and the wires are identical, the chances of affecting the magnitude of the turbulence are limited.

One problem with even an optimized wire shape, and hence an optimized, dissymmetric, contour shape, is that the fibre length distribution of the pulp suspension can vary according to such factors as the species of the original wood from which the pulp was derived, the means of reducing the wood to fibres and the subsequent processing of the fibres. The fibre length distribution can even change within a multi-stage screening system because fibre fractionation within one stage of screening will alter the fibre length distribution for subsequent screening stages. The problem of having various fibre length distributions in different screening applications has been resolved by having a range of wire widths available for a particular overall wire cross-sectional shape. Different wire widths can thus be used in different cylinders in consideration of the particular fibre length distribution in the pulp to be screened.

Another problem with even an optimized, dissymmetric, contour shape, is that some mill applications have a particular need for increased screen capacity while other mill applications have a particular need for increased debris removal or for an increased level of fibre fractionation. A change in the size of the opening could be used to provide this trade-off in performance, but mill applications may stipulate a particular opening size to ensure a particular level of debris removal, especially to guard against the passage of debris that are larger than the stipulated opening size. A solution to this problem is obtained by providing different contour depths for different screen cylinders. A deeper contour generally provides increased capacity, while a shallower contour generally provides increased debris removal efficiency and a higher level of fibre fractionation. Changes in contour depth can be achieved by tilting the wires slightly or by changing the cross-sectional wire shape while still maintaining the overall contour design, or by both.

Yet another problem exists for coarse screening and other pulp screening applications where the incoming pulp is characterized by: a very high level of contaminants, abrasive contaminants, relatively large and often stringy contaminants, contaminants called pulp flakes, which are formed of strongly-bonded pulp fibres, or most typically a combination of these problematic pulp constituents. Such pulp suspensions can be created, for example, from post-consumer, recycled pulp furnishes, such as old corrugated containers that have received only a preliminary level of treatment and where only a minimal amount of the contaminants has been removed. The large contaminants in this suspension may become wedged within the screen cylinder openings and will require a significantly higher level and scale of turbulence than is provided by the aforementioned cylinder contours. The pulp flakes may be rejected by the pulp screen as contaminants which, in turn, results in the loss of potentially good fibre. In addition, the large and stringy contaminants may agglomerate into very large masses and become wedged between the screen cylinder and rotor.

A solution to this problem has been found by adding bars to the surface of the screen cylinder facing the pulp suspension to be screened. The bars typically extend the full length of the cylinder and are aligned either parallel to the cylinder axis, and thus parallel to the screen wires, or at a relatively small angle to the cylinder axis. There will be many times fewer bars than cylinder wires. The bars act to create a much deeper surface feature compared to the contours found in the plurality of screen cylinder wires. Unlike the wire contours, the bars are not intended to streamline the flow flowing into and through the openings or to produce micro-turbulence, but instead are intended to provide a somewhat different and substantially more aggressive mechanical action. The bars generate macro-turbulence, shearing forces and particle impact, and thus provide a distinct and complementary function to the function of the wire contours.

In particular, the bars are intended to do the following: First, the bars may provide large-scale macro-turbulence that increases screen cylinder capacity and avoids blockage of the cylinder openings. Second, the bars may act on pulp flakes through impact and fluid shear to break apart the flakes and create useful fibre from flakes that would otherwise be rejected as debris. Third, the bars may help avoid the agglomeration of plastic strings and other large debris that could jam within pulp screens treating highly-contaminated pulp suspensions. Finally, the bars may decelerate the pulp suspension and especially the abrasive contaminants in the suspension to reduce wear on the screen contours.

The bars are typically rectangular in cross-section. They can be applied to cylinders made of a plurality of wires either by attaching the bars to the surface of the wires facing the pulp to be screened, or by installing the bars on top of wires that have been modified to receive the bars, or in place of certain wires, as described in U.S. Pat. No. 5,472,095. The most typical approach, however, is to install the bars by welding them onto the surface of the wires facing the pulp to be screened using either a fillet or stitch weld along the sides of the bar that extend more or less axially.

There are some problems in this approach, however: First, the welding operation is an additional and time-consuming step in manufacturing. Second, the high temperatures used in welding can create distortions in the adjacent wires, which need to be very straight to ensure that the dimensions of the openings are accurate and precise. Third, fillet welds can block the openings adjacent the bar and lead to a loss in the open area of the screen cylinder and screen capacity. Fourth, the bars themselves can be quite wide and thus will further reduce the open area and screen capacity of the cylinder.

Instead of bars, one could consider using an array of wires with different cross-sectional shapes within a particular screen cylinder, as has been shown, for example, in U.S. Pat. No. 4,846,971 and U.S. Pat. No. 6,131,743. Such arrays could include a wire with a cross-sectional height that is greater than the other wires and that creates a distinctly deeper contour compared to some of the adjacent wires, or even to include a wire with a large, rectangular head that is like the shape of a bar.

WO-A1-03102297 may be taken as a further more detailed example of a cylinder comprising two different wires for forming the surface. The WO-document discusses a screen basket where the screen cylinder is formed of a plurality of first bars having a shaped end and a plurality of second bars having a shaped end. The screen surface is formed of the first and the second bars such that after, for instance, five adjacent first bars there is a second bar, then five first bars and one second bar etc. The shaped ends of the first bars of the screen cylinder have a first radius and the shaped ends of the second bars have a second radius. The first radius is greater in an outflow screen cylinder than the second radius. In other words, the shaped ends of the second bars extend farther from support rings common to both the first and the second bars, the rings supporting both the first and the second bars at their ends opposite to the shaped ends thereof. Both the first and the second bars have surfaces slanting in the same direction. The basic idea of providing the screen cylinder with the second bars having their shaped ends extending at a smaller radius than the shaped ends of the first bars, is to keep abrasive solid particles from abrading the shaped ends of the first bars until the shaped ends of the second bars have worn out significantly. However, as the function of the shaped ends of the second bars extending higher in the screening cavity than the first wires is to wear out and by doing that to protect the shaped ends of the first wires from wearing, the extension of the shaped ends of the second wires above the shaped ends of the first wires (radius 11a minus radius 10a in FIG. 4 of the WO-document) is, in accordance with the drawings of the WO-document of the order of the width of the screening slot or even less, i.e. usually between about 0.2 and 0.7 mm. In other words, the WO-document teaches that, in order to protect the shaped ends of the first wires, the second wires need not be significantly higher, but have an advantageously formed shaped end for directing the abrasive particles to a path above the first wires. Thus the gently sloping leading surface of the shaped ends of the second wires is crucial for the operation of the screen basket of the WO-document, i.e. aiding in throwing the abrasive particles to such a path that passes the downstream first wires without wearing such. Furthermore, the shaped end of the second wire has a bevelled trailing surface to control the turbulence in front of the screening opening or slot.

However, performed experiments have shown that simply using incrementally larger forms of wires and, for instance, deeper contours do not lead to the desired results, which are to improve capacity, to efficiently break up fiber flakes, to achieve efficient debris removal, and to ensure reliable operation in the presence of stringy contaminants. The problem with simply using incrementally deeper contours to address the problems of coarse screening and similar screening processes is that contour depth has been found with screen wires to merely alter the relative strength of the actions associated with these contours, so that one can seek to alternatively achieve either more capacity or a higher level of debris removal. In coarse screening and similar screening processes, one typically needs a more fundamental change in the screening action to provide the aforementioned macro-turbulence, shearing forces and particle impact.

In addition, various wire shapes that might be considered to replace bars are not of optimal shape for the intended actions. These bar-wire shapes typically present a symmetric surface feature, while the strong circumferential flow suggests the need for very different actions from the leading and trailing edges of the bars. One important problem that is not addressed by simply having different simple cross-sectional shapes for the wires that would replace the bars, and generate a symmetric surface feature, is the need to eliminate the abrupt downward step on the downstream side of these wires. The abrupt step on the downstream side leads to the creation of a bound vortex or recirculating zone and, in turn, the possibility of increased power consumption by the rotor and accelerated wear on the adjacent downstream wires. Another important problem that is typically not addressed is the need to preserve an abrupt upward step with a sharp edge to provide the impact and shear that is believed to be important for dispersing pulp flakes.

Another problem to be considered is the functional lifetime of any wire shape that is intended as a replacement for the bars. The need for an upward step with a sharp edge along with the presence of the aforementioned abrasive contaminants can lead to rapid wear of the bar and compromised a subsequent drop in performance. Hard chrome plating and alternate wear-resistant surface treatments have been traditionally applied to cylinders to minimize wear and extend lifetime. In addition, the bars have sometimes been made of materials that are harder and more wear resistant than the material used for the wires in respect of the especially high-wear environment of the bars.

### SUMMARY OF THE INVENTION

It is therefore an object of the present invention to minimize the above-mentioned drawbacks and provide an improved screen cylinder.

It is also an object of the present invention to provide an easily manufactured and assembled screen cylinder with a minimal amount of manufacturing steps, and preferentially a single manufacturing method to attach wires with different purposes to the cylinder structure.

It is also an object of the present invention to minimize the inventory of wires and related components that must be maintained in stock to create different cylinders for different applications and thus to minimize inventory costs.

It is also an object of the present invention to address the disparate challenges of coarse pulp screening and similar screening applications, which are superimposed upon the already-significant challenges of the typical pulp screening process.

It is also an object of the present invention to maximize the open area of the screen cylinder by not blocking slots with weld and by including, wherever possible, functional openings between the wires that would replace the bars.

It is also an object of the present invention that the wires that would replace the bars would be amenable to wear-resistant technologies such as specialized coatings or the use of alternate wire materials.

In accordance with a preferred embodiment of the invention, the cylinder is made of a plurality of wires, which includes circumferential sections comprising at least one, and typically several, screen-wires and circumferential sections comprising at least one, and typically several, “bar-wires”. These so-called “bar-wires” are wires that are specifically intended to reproduce and ideally enhance the action of bars that have been used in traditional wedgewire cylinders where bars are welded to the surface of the screen-wires. Several bar-wires may be arranged in series with the intent of providing a more gradual downstream slope among the collection of bar-wires, or a higher upward step on the upstream side of the bar-wire section. Alternatively, a saw-tooth arrangement of bar-wires might be used to provide a more complex action on the pulp suspension to be screened. The use of several adjacent bar-wires may also follow from the need to create a stronger support structure given that these bar-wires may be subjected to the impact of large and hard contaminants. The use of several bar-wires rather than a single bar-wire also provides an additional degree-of-freedom for designers seeking to use an existing inventory of wires and wire shapes.

It is most desirable that the method of manufacturing a screen cylinder according to the invention uses essentially the same method to secure all of the screen-wires and bar-wires in the screen cylinder structure. However, additional reinforcement, by means of for instance welding, may be used for securing either the screen-wires, the bar-wires or both. The bar-wires may be drawn from the same inventory of wires as the screen-wires. It may also be that a wire with a greater wire height than the screen-wires is used for the bar-wires. Alternatively, or in addition, bar-wires may be secured into the cylinder structure in a way that elevates certain bar-wires relative to the adjacent screen-wires. Accordingly, there would be a commonality among the screen-wires and bar-wires, and especially to the the foot part of the wires, i.e. opposite the end of the wires that face the pulp to be screened, whereby this foot-part feature fits into the notches, recesses or openings in the receiving part of the screen cylinder structure related to the mechanism of securing the wires to the cylinder.

An important feature of the screen cylinder of the present invention is that the surfaces of the screen-wires and the bar-wires that face the pulp to be screened are predominantly dissymmetric, when traversed circumferentially. This dissymmetry can thus be created by altering the cross-sectional shapes of the screen-wires and bar-wires, or by tilting the screen-wires or bar-wires, or by a combination of these effects. The dissymmetry thus creates an orientation relative to the circumferential flow. The surface of at least one of the bar-wires in each bar-wire circumferential section has a reverse orientation to the surfaces of the majority of the screen-wires.

Most typically, the tops or peaks of at least some of the bar-wires will be elevated relative to the tops of the majority of the screen-wires.

Also, the tops of the bar-wires have a sharp leading edge possibly formed of wear resistant material or provided with a wear resistant coating.

The combination of these effects provide a relatively abrupt upward-step feature on the upstream side of the bar-wire section, and a generally-sloped downstream side of the bar-wire section to avoid the creation of a recirculating zone immediately downstream of the bar-wire section where accelerated wear and wasteful energy loss could occur.

The characterizing features of the screen cylinder of the present invention will become apparent from the appended patent claims.

### BRIEF DESCRIPTION OF THE DRAWINGS

In the following, the screen cylinder will be explained in a more detailed manner with reference to the accompanying drawings of which:

FIG. 1 illustrates schematically a wire screen cylinder of prior art;

FIG. 2 illustrates schematically a section of a screen cylinder of prior art showing the dissymmetric screen wires and contours and the circumferential flow induced by the rotor;

FIG. 3 illustrates schematically a section of a screen cylinder of prior art showing a bar attached to the plurality of screen-wires;

FIG. 4 illustrates schematically a section of a screen cylinder in accordance with a first preferred embodiment of the present invention;

FIG. 5 illustrates schematically and in an enlarged scale a section of a screen cylinder in accordance with a first preferred embodiment of the present invention;

FIG. 6 illustrates schematically a section of a prior screen cylinder typically used for filtration and formed of symmetric screen-wires and a symmetric bar-wire therebetween;

FIG. 7 illustrates schematically a section of a screen cylinder in accordance with a second preferred embodiment of the present invention;

FIG. 8 illustrates various alternatives for the cross section of the screen-wires or bar-wires used in the present invention;

FIG. 9 illustrates schematically a section of a screen cylinder in accordance with a third preferred embodiment of the present invention;

FIG. 10 illustrates schematically a section of a screen cylinder in accordance with a fourth preferred embodiment of the present invention;

FIG. 11 illustrates schematically a section of a screen cylinder in accordance with a fifth preferred embodiment of the present invention; and

FIG. 12 illustrates schematically a section of a screen cylinder in accordance with a sixth preferred embodiment of the present invention.

### DETAILED DESCRIPTION OF THE INVENTION

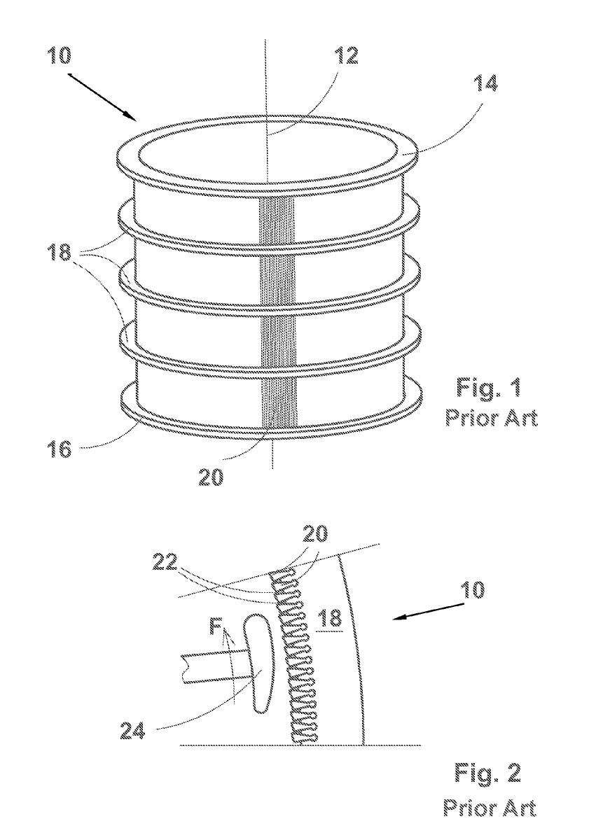

FIG. 1 shows, in a very schematic and simplified manner, a wedge wire screen cylinder, 10, of prior art about a central axis, 12. The end rings, or the top and bottom rings of the screen cylinder, are shown as 14 and 16 respectively. Three support elements, here rings, 18, are shown, but there will more typically be many such support elements, 18, spaced axially. The prior art screen cylinder, 10, is made of substantially axially-oriented screen wires, 20, which are the so-called “wedge wires”. Originally the generally triangular wire cross-section resembled a wedge, and most often still do. These screen wires are attached to support elements, 18, and, on the other hand, at their axial ends either directly or via the outermost support rings to the end rings, 14 and 16, situated at the opposite ends of the screen cylinder, 10. Note that in this schematic drawing, the screen wires, 20, have not been sketched in detail or to scale and only a few of the screen wires are shown, while a typical screen cylinder would have a plurality of screen wires extending essentially around the full circumference of the screen cylinder. Most often, the wedgewire screen cylinder, 10, is of the so-called “outflow” type like in FIG. 1. This means that the screening surface facing the pulp suspension to be screened is the inner surface of the screen cylinder, 10, and the flow of accept pulp proceeds radially outward through the cylinder openings. To make this operation possible, the screen wires are normally attached to the radially inward rim of the support elements, i.e. the support rings, 18, in this case. However, so-called “inflow” type wedgewire screen cylinders are also known whereby the screening surface facing the pulp suspension to be screened is the outward surface of the screen cylinder, 10, and the accept flow proceeds radially inward through the cylinder openings. In either the outflow or the inflow configuration, elements of the support structure, in this case the support rings, 18, are arranged along the length of the screen wires, 20, in such a manner that the axial distance between the support rings, 18, is about 20 to 100 mm depending on the size and the application of the screen cylinder, 10.

FIG. 2 illustrates schematically a section of a screen cylinder, 10, of prior art showing the dissymmetric screen wires, 20, with dissymmetric contours and the circumferential flow, F, induced by the rotor and, in particular, by the rotor foil, 24. The distance between the adjacent screen wires, 20, defines screen cylinder openings, or screen slots, 22. The slot width is normally set at some particular value in the range of 0.10 to 0.30 mm depending on the application of the screen cylinder, 10. However, in coarse screening applications, slot widths as large as 0.80 mm may be used. Conversely, future design and manufacturing improvements may make slot widths less than 0.10 mm practical. A common way of fastening and properly positioning the screen wires, 20, to the support elements or support rings, 18, is to provide transverse notches or recesses or openings in the support elements, 18, where the screen wires, 20, are inserted. The screen wires, 20, may include a feature on the aforementioned foot part of the wire whereby this foot-part feature fits into the notches, recesses or openings. A further manufacturing step, such as welding, gluing, soldering, riveting or clamping, is then typically taken after the wires, 20, are installed in the support elements, 18, to attach the wires even more securely, and especially to avoid any axial movement of the wire. The support elements, 18, may have a simple rectangular cross-section or they may have a substantially more complex shape to support a clamping or riveting action, for example. The screen wires, 20, may be installed into the support elements, 18, while the support elements are in a circular form, i.e. as a support ring. Alternatively, the screen wires, 20, may be installed in the support elements, 18, while the support elements are flat and this assembled mat of screen wires, 20, and support elements, 18, is then formed into a cylinder.

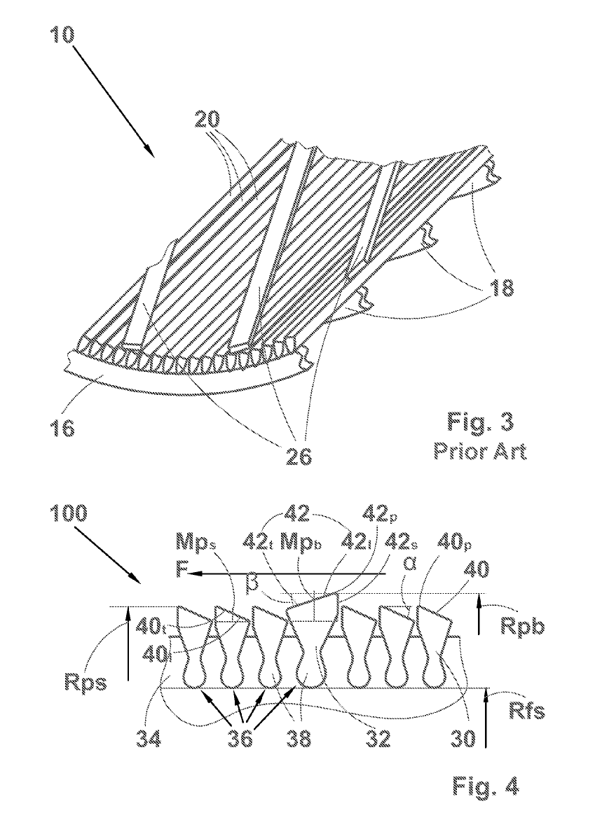

FIG. 3 illustrates schematically a section of a screen cylinder, 10, of prior art (U.S. Pat. No. 5,472,095) showing bars, 26, attached to the plurality of screen wires, 20, and in particular, to the surface of the screen cylinder facing the pulp suspension to be screened. The bars, 26, extend the full length of the cylinder, 10, although only a small section of the cylinder is shown in FIG. 3. The bars are aligned either parallel to the cylinder axis, 12, and thus parallel to the screen wires, 20, or at a relatively small angle to the cylinder axis, as is shown in FIG. 3. There will be many times fewer bars, 26, than cylinder wires, 20. The bars, 26, are typically rectangular in cross-section. They can be applied to cylinders made of a plurality of wires either by attaching the bars to the surface of the wires facing the pulp to be screened, or by installing the bars on top of wires that have been modified to receive the bars, or in place of certain wires. The most typical approach, however, is to install the bars by welding them onto the surface of the wires facing the pulp to be screened using either a fillet or stitch weld along the sides of the bar that extend more or less axially.

FIG. 4 illustrates schematically a section 100 of a screen cylinder in accordance with a first preferred embodiment of the present invention. The screen cylinder section 100 is made of a plurality of wire sections, which include a plurality of screen-wire sections and a plurality of bar-wire sections (shown in FIGS. 4-12). Each screen-wire section is formed of at least one and preferably a plurality of screen-wires, 30. The bar-wire sections comprise at least one (shown in FIGS. 4, 5, 7) and typically several (shown in FIGS. 9-12) bar-wires, 32. The screen-wires and the bar-wires are fastened to a support structure, 34. Here the support structure is formed of a plurality of support rings, 34, provided with transverse notches, 36, into which the foot, 38, of each of the screen-wires, 30, and each of the bar-wires, 32, is fitted. The support structure may be, in addition to support rings, whatever type is applicable with wedge wires like, for instance, a skeleton (CA-A1-2 609 881) or a frame cylinder construction (U.S. Pat. No. 6,915,910) to which the wedge wires are either directly attached or via the support rings supported.

An essential feature of the screen cylinder of the present invention, as shown in FIGS. 4, 5 and 7, is that the a majority of the screen-wires, 30, 130, and the bar-wires, 32, 132, have dissymmetric (in relation to a radial centreline plane) wire head surfaces, 40, 140 and 42, 142 as opposed to a prior art screen cylinder illustrated in FIG. 6, where the head surfaces are symmetric in relation to a radial centreline plane. The wire head is defined here as the part of the wire above a line that connects the entry to the openings on either side of the wire. The openings, in turn, are defined as the location of the minimum gap between adjacent wires.

The wire head surface can be defined by the changing radius relative to the central axis, 12 (shown in FIG. 1), of the screen cylinder as one moves along the surface circumferentially from one opening to the next. Different wire shapes create different changes in radius, with the radius instantaneously increasing, decreasing, or remaining constant as a trace is made circumferentially. For a symmetric wire surface, the values of the radius relative to the location of the slots are the same regardless of whether one moves clockwise or counter clockwise along the surface. For a dissymmetric surface the values are not independent of the direction of motion, not at least for the entire width of the wire.

The dissymmetry of the screen-wires, 30, and the bar-wires, 32, is expressed in the radius of the various parts of the head surfaces, 40 and 42. The radius is measured, naturally, from the axis of the screen cylinder. Here, in FIG. 4, an inflow screen cylinder is shown, i.e. a screen cylinder where the pulp to be screened is fed to the outside of the screen cylinder and the accepts pass the cylinder slots to a direction towards the axis of the cylinder. Thus, the screen-wire 30 has two radii between which the screen-wire fits, i.e. a foot radius, Rfs, and a radius, Rps, of the peak circumference, i.e. the radius of the point or peak, 40p, at the head surface, 40, farthest away from the foot, 38. In a corresponding manner, the bar-wire, 32, has two radii between which the bar-wire fits, i.e. a foot radius, Rfb, (here it happens to be the same as the foot radius, Rfs, of the screen-wire, but the, Rfb, may be either smaller or greater than, Rfs) and a radius, Rpb, of the peak circumference, i.e. the radius of the point or peak, 42p, at the head surface, 42, farthest away from the foot, 38.

As to the screen-wire, 30, it has on its head surface, 40, a circumferential mid-point, Mps, i.e. a point that is located by drawing a circumferential arc between the entrances to two adjacent openings (defining a circumferential width of a wire at the level of the entries) and drawing a perpendicular bisector thereto, whereby the circumferential mid-point is the crossing point of the bisector and the head surface, 40. The mid-point, Mps, divides the head surface, 40, into two parts: a first surface part, 40l, and a second surface part, 40t. The first surface part, 40l, may also be called a leading surface part as it is the first surface part receiving the flow of pulp or fibre suspension. The second surface part, 40t, may also be called a trailing surface part, as it is the surface part allowing the flow of pulp or fibre suspension to be discharged from above the screen-wire. In one particular embodiment, when considering an outflow screen, the average radius of the first surface part, 40l, of the screen-wire, 30, is greater than that of the second surface part, i.e. the trailing surface part, 40t, of the head surface, 40. In another particular embodiment, when considering an inflow screen, the average radius of the first surface part, 40l, of the screen-wire, 30, is less than that of the second surface part, i.e. the trailing surface part, 40t, of the head surface, 40.

As to the bar-wire, 32, it has on its head surface 42 a circumferential mid-point Mpb, i.e. a point that is located by drawing a circumferential arc between the entrance to two adjacent openings (defining a circumferential width of a wire at the level of the entries) and drawing a perpendicular bisector thereto, whereby the circumferential mid-point Mpb is the crossing point of the bisector and the head surface 42. The mid-point Mpb divides the head surface, 42, into two parts: a first surface part, 42l, and a second surface part, 42t. The first surface part, 42l, may also be called a leading surface part as it is the first surface part receiving the flow of pulp or fibre suspension. The second surface part, 42t, may also be called a trailing surface part, as it is the surface part allowing the flow of pulp or fibre suspension to be discharged from above the bar-wire. In one particular embodiment, when considering an outflow screen, the average radius of the first surface part, 42l, of the bar-wire, 32, is less than that of the second surface part, i.e. the trailing surface part, 42t, of the head surface, 42. In another particular embodiment, when concerning an inflow screen, the average radius of the first surface part, 42l, of the bar-wire, 32, is greater than that of the second surface part, i.e. the trailing surface part, 42t, of the head surface, 42.

Another essential feature of the invention is that the peak 40p of the screen-wire 30 is at the second or trailing surface part 40t thereof, whereas the peak 42p of the bar-wire 32 is at the leading or first surface part 42l thereof. However, in case the peak/s of the screen-wire and/or bar-wire is at the mid-point Mps and/or Mpb, the peak/s is/are considered to be at the above mentioned surface parts. But in such a case, naturally, the average radius of the surface part in question defines the required dissymmetry of the screen-wire or bar-wire as discussed on the two closest paragraphs above.

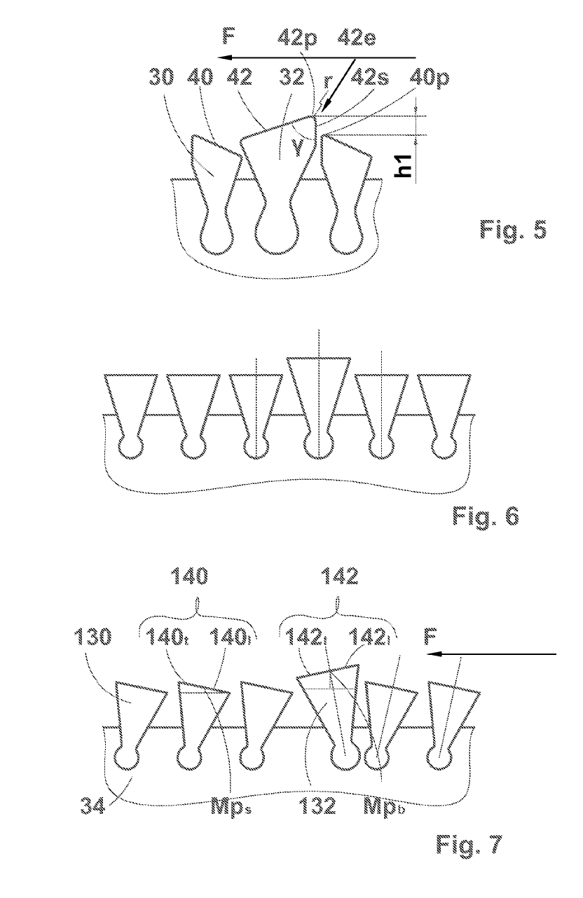

A further essential feature of the present invention is discussed in FIG. 5 where a bar-wire 32, two screen-wires 30 and the direction of rotation of the rotor by means of arrow F are shown. The feature essential in view of breaking the pulp flakes is the sharp leading edge 42e of the bar-wire 32. The leading edge 42e is located between the head surface 42 and the side surface 42s of the bar-wire. The side surface 42s is the surface at the wire head being positioned at a side of the head surface, and, when in use, facing the flow of pulp suspension. The leading edge 42e could be perfectly sharp but it has, in practice always for manufacturing reasons, a small radius r, (or the radial extension of a bevel) normally of the order of from one tenth to a few tenths of a millimeter. However, to define the required sharpness of the leading edge 42e the dimension of the radius is compared to the radial height h1, i.e. a radial distance between the peaks 40p of the screen-wire 30 and the peak 42p of the bar wire 32. The sharpness of the leading edge 42e is defined as the radius r being at most one half of the radial height h1, preferably at most one quarter of the radial height. Additionally, the proper operation of the bar-wire 32 requires that the trailing part 42t of the head surface 42 of the bar-wire 32 is slanting from the leading part 42l. Thus, preferably but not necessarily, to guarantee efficient breaking up of fiber flakes at the leading edge 42e the leading edge angle γ, i.e. the angle between the leading part 42l of the head surface 42 and the side surface 42s of the bar wire 32 is between 45 and 90 degrees.

To clarify that the same approach applies to wires having themselves a symmetric cross-section FIGS. 6 and 7 have been sketched. FIG. 6 illustrates schematically a section of a prior art screen cylinder of the type used in filtration having symmetric screen-wires and a symmetric bar-wire therebetween. Since both the screen-wires and the bar-wire have been fastened to the support structure such that their centreline plane, i.e. plane of symmetry (shown by vertical lines), is radial, the screen surface facing the pulp that is to be screened is flat, i.e. non-contoured, except for the bar-wire elevated from the level of the screen-wires. However, now that the head surface of the bar-wire is not slanting the head surface of the bar-wire guides most of the flow past the first screening slot immediately following the bar-wire, and, additionally, creates a strong field of turbulence that subjects a strong wearing action to the first screen-wire downstream of the bar-wire.

In FIG. 7 a section of a screen cylinder in accordance with a second preferred embodiment of the present invention is schematically illustrated. Here the screen-wires, 130, and the bar-wire, 132, have, again, a symmetric cross section, but, as the axis or plane of symmetry (shown by inclined lines) is not in radial direction, i.e. the wires, 130 and 132, are installed to the support structure, 34, in a tilted position, the screen surface has a contour. Now that the screen-wires, 130, are tilted to the right and the bar-wire, 132, is tilted to the left, i.e. to the opposite or reverse direction in relation to the screen-wires, an abrupt upward step is created in the flow direction F. In this embodiment, too, the heads of the screen-wires, 130, have a circumferential mid-point, Mps, a first or leading surface part, 140l, and a second or trailing surface part, 140t. In a corresponding manner, the heads of the bar-wires, 132, have a circumferential mid-point, Mpb, a first or leading surface part, 142l, and a second or trailing surface part, 142t. Thus, in accordance with the present invention, the peak of the screen-wires, 130, is at the trailing or second surface part, 140t, whereas the peak of the bar-wire, 132, is located at the first or leading surface part, 142l.

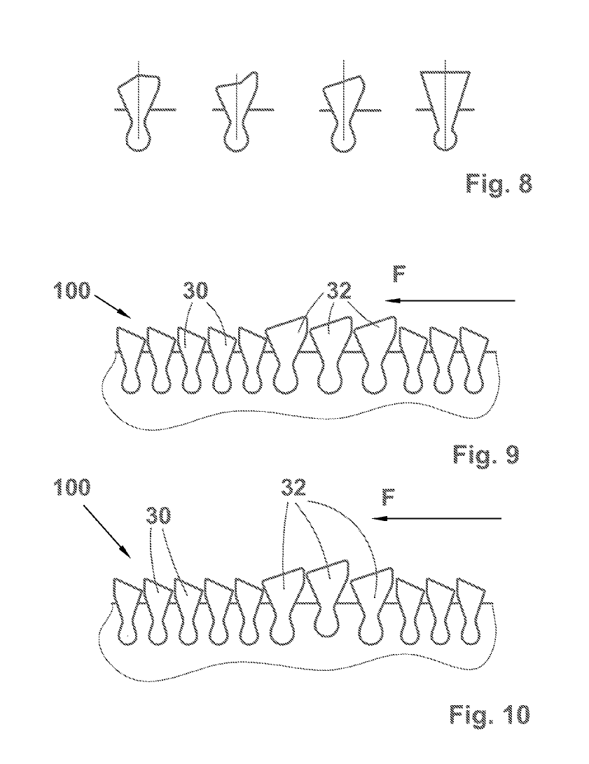

In FIG. 8 a few cross-sections of screen-wires or bar-wires are shown with their centreline planes. The three first wires from the left are not symmetrical in relation to the centreline plane of the wire, whereas the rightmost wire is symmetrical (requiring, when taken into use, tilting). There are a few features in common to all shown variations of the bar-wire. Firstly, the second or trailing surface part of the head surface of the bar-wire, i.e. the surface part to the left from the vertical line representing the centreline plane of the wire, is sloping from the first or leading surface part of the head surface towards the support structure represented by the horizontal line. The angle of slope, i.e. the angle in a radial plane between the second or trailing surface and the circumferential direction, is, preferably but not necessarily, of the order of 15 to 45 degrees, more preferably between 15 and 35 degrees. Secondly, the peak of the head surface of the bar-wire is located at the first or leading surface part of the bar-wire. Thirdly, the leading edge between the first or leading surface part of the head surface of the bar-wire and the side surface is sharp, though for manufacturing reasons rounded (or bevelled). And fourthly, the peak may, however, be located at a distance from the side surface, as shown by the leftmost bar-wire, or the first or leading surface part of the head surface may be flat, i.e. positioned in circumferential direction, that is, in a direction perpendicular to the centreline plane of the bar-wire. The latter option is, in a way, a preferred one, as it offers more bar-wire material to wear out, i.e. increases the lifetime of the bar-wire and the entire screen cylinder. Thus it is clear that all both disclosed and non-disclosed non-symmetrical wire cross sections may be used in the invention in both tilted and non-tilted (centreline plane in radial direction) configuration, and that all such wires that have a symmetrical cross-section in relation to its centreline plane may be arranged in tilted position to fulfil the requirements of the present invention. Also, the cross-sections of the screen-wires and the bar-wires of a screen cylinder may be similar, but it is as well possible to use different cross sections.

As has been discussed above in connection with FIGS. 4, 5 and 7, the dissymmetry of the contour of the bar-wire, 32/132, is opposite, or in reverse orientation, to that of more common screen-wire, 30/130, i.e. the leading or first surface part, 42l/142l of the head surface, 42/142, is at a shorter radial average distance from the axis of the screen cylinder in an outflow screen cylinder than the trailing or second surface part, 42t/142t, of the head surface, 42/142, for this typical example. In an inflow cylinder the leading or first surface part, 42l/142l, of the head surface, 42/142, is at a greater radial average distance from the axis of the screen cylinder than the trailing or second surface part, 42t/142t, of the head surface, 42/142.

Thus, the peak, 42p, of the head surface, 42/142, i.e. the highest part or point thereof, is located on the leading surface part, 42l/142l, of the head surface, 42/142. In other words, and in general terms, the bar-wires, 32/132, have a reverse orientation to the more common screen-wires, 30/130. The “reverse orientation” above means that the screen wires have at their head, i.e. the surface facing away from the support structure, an inclined slope generally facing the impinging pulp suspension flow along the screen surface for the particular wire shapes shown in FIGS. 4, 5 and 7, whereas the bar-wires have at their head surface facing away from the support structure an average inclined slope facing away from the impinging pulp suspension flow along the screen surface. In other words, the average angle α of slope of the screen wires open in the direction of the pulp flow along the screen surface, whereas the average angle β of slope of the bar-wires opens against the direction of the pulp flow, i.e. the average angles α and β of slope of the screen-wires and the bar-wires open in opposite directions for the particular wire shapes shown in FIGS. 4, 5 and 7.

The leading part 42l of the head surface 42 of the bar-wire 32 joins, at a preferred but not necessary angle γ of 45 to 90 degrees, preferably of 60-85 degrees, to a side surface 42s of the head 42 (when not taking into account the rounding or bevel), for the particular wire shape shown in FIG. 4. The side surface 42s is, preferably, at an angle of 70-110 degrees to the circumferential direction represented by the flow, F, or at an angle of ±20 degrees to the radial plane of the bar-wire, 32, established by the cylinder axis.

By means of this configuration of the head, 42, of the bar-wire, 32, the flow of the pulp suspension in the direction, F, meets the side surface, 42s, which creates a substantially more aggressive mechanical action than any screen-wire, 30. The bar-wire, 32, with its side surface, 42s, leading edge 42e, and the leading surface part, 421, generates macro-turbulence, shearing forces and particle impact, and thus provides a distinct and complementary function to the function of the more common screen-wire contours.

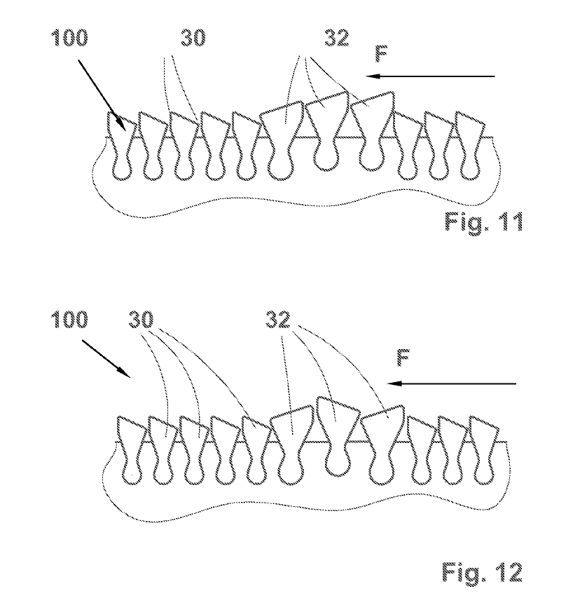

FIGS. 9-12 illustrate schematically screen cylinder designs of other preferred embodiments of the present invention, where a bar-wire section, comprising several bar-wires, 32, arranged in series, is located among the more common screen-wires, 30, of screen-wire sections. The bar-wire sections, comprising at least one but often several bar-wires, 32, are preferably, but not necessarily, evenly spaced within the screen cylinder circumference. The percentage of the circumference occupied by bar-wires is in the range of 1 to 20%, and typically between 5 and 15%. The intent of arranging several bar-wires in series may be to provide: a) a saw-tooth arrangement for a more complex action by, for instance, three bar-wires, 32, arranged at the same height with one another (FIG. 9); b) a more gradual downstream slope among the series of bar-wires, 32, (FIG. 10); c) a higher upward step on the upstream side of the collection of bar-wires, 32 (FIG. 11), where the third (the right-hand side) bar-wire could as well be arranged somewhat higher in the series, whereby an even higher step would be provided between the screen-wires and the leading (right-hand side) bar-wire, or d) an arrangement (FIG. 12), where the central bar-wire, in the bar-wire section, is not reversed in relation to the screen-wires 30.

As to dimensioning the bar-wires, and especially the radial elevation h1 (FIG. 5) of the bar-wire peak relative to the peak of the screen-wires, the elevation h1 is between 1 and 8 mm, preferably between 1 and 6 mm, and more preferably between 1 and 4 mm. When referring to FIG. 4 and the discussion in connection therewith, the above elevation h1 may be calculated as the difference between radii Rpb and Rps, i.e. Rpb-Rps (for an inflow screen) or Rps-Rpb (for an outflow screen).

The use of several adjacent bar-wires may also follow from the need to create a stronger support structure given that the bar-wires may be subjected to the impact of large and hard contaminants. The use of several bar-wires rather than a single bar-wire provides an additional degree-of-freedom for designers seeking to use an existing inventory of wires and wire shapes. Regardless of whether one or several bar-wires are used in a bar-wire circumferential section, a majority of the screen-wire and bar-wire heads are both generally dissymmetric and, in particular, at least one of the bar-wire heads in the bar-wire section has a reverse orientation to the screen-wire heads. Alternatively, the screen-wires and the bar-wires may be tilted but with the same final result where at least one of the bar-wire surfaces has a reverse orientation to the screen-wire surfaces.

In addition to solving all of the aforementioned problems with the current design of a cylinder with bars, the proposed invention also minimizes the required inventories of wire types, since one may be able to simply reverse the direction of a screen-wire to create a bar-wire. It will typically be advantageous to have the bar-wires appear as larger than the screen-wires, but this can be achieved in the following ways or some combination thereof: First, in cases where different wires are maintained in inventory to provide different screen-wire contour depths for different cylinders, a larger wire, with increased contour depth, may be selected for use as the bar-wire. Second, in cases where different contour depths are achieved by wire tilting, the bar-wire would be both reversed and installed with a reduced amount of tilt. Finally, the means of attaching the wire to the support structure could be modified so as to make the bar-wire appear higher. For example, where the screen wires, including the bar-wires, are installed in notches in a support ring, the notches for the bar-wires would be formed at a location closer to the notched edge of the support ring than for the screen-wires.

Hard chrome plating and alternate wear-resistant surface treatments have been traditionally applied to cylinders to minimize wear and extend lifetime. In addition, the bars have sometimes been made of materials which are harder and more wear resistant, such as Stellite™, than the 316L stainless steel material commonly used for the wires in respect of the especially high-wear environment of the bars.

As can be seen from the above description, a new screen cylinder has been developed, eliminating at least some disadvantages of the prior art screen cylinders. While the invention has been herein described by way of examples in connection with what are at present considered to be the preferred embodiments, it is to be understood that the invention is not limited to the disclosed embodiments, but is intended to cover various combinations and/or modifications of its features and other applications within the scope of the invention as defined in the appended claims.

1. A screen cylinder comprising
a support structure, a plurality of wire sections, and an axis,
the plurality of wire sections including at least a plurality of screen-wire sections and a plurality of bar-wire sections,
each screen-wire section comprising at least one screen-wire,
each bar-wire section comprising at least one bar-wire,
the support structure having a radially inner and a radially outer circumference,
the support structure being provided with means for fastening the screen-wires and bar-wires at one of the outer circumference and the inner circumference,
the screen wires and the bar wires being fastened to the support structure axially and at a small spacing parallel to each other by the fastening means,
the screen-wires and the bar wires forming a screening surface facing away from the support structure,
the small spacing between the screen wires and the bar-wires forming the screening openings for allowing an accept portion of a pulp or fiber suspension to flow therethrough,
at least a majority of the screen-wires having a head surface facing away from the support structure, the head surface being formed of a first surface part and a second surface part,
the head surface of the at least the majority of the screen wires having a peak at the second surface part and a peak circumference with a radius, Rps, relative to the cylinder axis,
at least one bar-wire having a head surface facing away from the support structure, the head surface being formed of a first surface part and a second surface part,
the head surface of the at least one bar-wire having a peak and a peak circumference with a radius, Rpb, relative to the cylinder axis,
the peak circumference of the head surface of the at least one bar-wire extending, in a direction away from the support structure, at a distance h1 from the peak circumference of the head surface of the at least the majority of the screen wires,
wherein the peak of the head surface of the at least one bar-wire is located at the first surface part, the head surfaces of the screen wires has an average angle α of slope and the head surfaces of the bar wires have an average angle β of slope, the angles α and β opening in opposite directions,
wherein the bar-wire has, at a side of the peak of the head surface, a side surface, when in use, facing a flow of pulp suspension, and a leading edge between the side surface and the head surface, and
wherein the leading edge has a radius, the radius being at most one half of the distance h1.

2. The screen cylinder as recited in claim 1, wherein,
when the screen cylinder comprises an inflow cylinder,
the peak of the head surface of the at least one bar-wire has a radius relative to the cylinder axis greater than that of the peak of the at least the majority of the screen wires, and,
when the screen cylinder comprises an outflow cylinder,
the peak of the head surface of the at least one bar-wire has a radius relative to the cylinder axis less than that of the peak of the at least the majority of the screen wires.

3. The screen cylinder as recited in claim 1, wherein the leading edge has a radius, the radius at most one fourth of the distance h1.

4. The screen cylinder as recited in claim 1, wherein the second surface part of the head surface of the bar-wire slopes from the first surface part of the head surface towards the support structure.

5. The screen cylinder as recited in claim 1, wherein the bar-wire sections are evenly spaced between the screen-wire sections.

6. The screen cylinder as recited in claim 1, wherein two or more bar-wires are next to one another in the bar-wire section.

7. The screen cylinder as recited in claim 1, wherein the bar-wire sections cover 1-20% of a screen cylinder circumference.

8. The screen cylinder as recited in claim 1, wherein the peak of each bar-wire in each bar-wire section has an equal elevation from the peaks of the at least the majority of the screen wires.

9. The screen cylinder as recited in claim 1, wherein the peak of one bar-wire in at least one bar-wire section has a different elevation than another bar-wire from the peaks of the at least the majority of the screen wires.

10. The screen cylinder as recited in claim 1, wherein the bar wires have a cross-section of equal shape with the at least the majority of the screen wires.

11. The screen cylinder as recited in claim 1, wherein the bar wires are tilted or installed in a higher location in the support structure than the screen wires.

12. The screen cylinder as recited in claim 1, wherein the support structure comprises a series of support rings and a frame cylinder.

13. The screen cylinder as recited in claim 1, wherein the bar-wires have a taller cross-section than the screen wires.

14. The screen cylinder as recited in claim 9, wherein the bar-wires are arranged in notches having a smaller radial depth within the support structure than notches in which the at least the majority of the screen wires are installed.

15. The screen cylinder as recited in claim 1, wherein the peak of each bar-wire extends, in a radial direction away from the support structure, 1-8 mm from the peak circumference of the at least the majority of the screen-wires.

16. The screen cylinder as recited in claim 1, wherein at least one of the screen-wires and the bar-wires are coated with a wear-resistant coating.

17. The screen cylinder as recited in claim 16, wherein the bar-wires are coated with a more wear-resistant coating than the screen-wires.

18. The screen cylinder as recited in claim 1, wherein at least one of the screen-wires and the bar-wires are made of a wear-resistant material.

19. The screen cylinder as recited in claim 18, wherein the at least one of the bar-wires is made of a more wear-resistant material than the at least one screen-wire.
